(19) United States
(12) Patent Application Publication
(10) Pub. No.: US 2012/0100247 A1
(43) Pub. Date: Apr. 26, 2012

(54) Performance Enhancing Composition and Method of Delivering Nutrients

(76) Inventors: Ralph Mario Ferrante, Upper Grandview, NY (US); Chad Kevin Cunningham, Tappan, NY (US)

(21) Appl. No.: 12/911,925

(22) Filed: Oct. 26, 2010

(51) Int. Cl. A23L 1/30; A23L 1/305; A23L 1/304

(52) U.S. Cl. 426/2; 426/541; 426/74

(57) ABSTRACT

An aqueous composition specifically adapted for supporting physical performance. The liquid composition comprises ribose, a saccharide such as glucose or dextrose, coenzyme Q10, and D-pinitol in conjunction with minerals, electrolytes, and creatine. The orally-consumed liquid composition may be sold in solid form, such as a powder, granulate, or tablet to be added to water or other fluid, or it may be sold as a shelf-stable ready-to-drink liquid. The liquid composition physiologically enhances essential energy stores and provides a supply of ingredients which support physiological generation and regeneration of ATP.

### I. BACKGROUND OF THE INVENTION

1. Field of the Invention

The present invention is directed to nutraceutical compositions which support physical performance, attenuate muscle fatigue, and enhance aerobic respiration utilization capacity. The composition may be prepared in the form of a ready-to-drink liquid composition, or a tablet, granulate, powder, or other solid form to be added to water or other fluid to form a drinkable liquid at the time of ingestion. Advantageously, the inventive composition enhances physiologically vital energy stores and the bio-available of adenosine triphosphate (ATP) energy reserves. The composition also provides for regeneration of ATP in skeletal muscle, increases the uptake and retention of creatine in skeletal muscle, and provides essential electrolytes and other ingredients to a consumer of the liquid composition.

More specifically, the present invention relates to a novel composition comprising ribose, a saccharide, coenzyme Q10, D-pinitol, and creatine. The composition may also contain minerals and electrolytes to stimulate and enhance generation of ATP activity in the body.

2. Description of the Related Art

The human body derives energy from carbohydrates, fats and proteins during chemical processes within the cells. The energy released from these nutrients is used to form the nucleotide ATP. ATP is used to promote three major categories of cellular function: membrane transport, synthesis of chemical compounds, and mechanical work. As cells use ATP to perform work, the ATP is chemically broken down into a pool of nucleotides, most of which are re-aminated and re-phosphorylated back to ATP. When intense exercise is repeated frequently, as in training, there is an accumulated loss of nucleotides from the muscle. The restoration of the nucleotide pool occurs mainly through de novo synthesis but also through the re-use of intracellular purines through the purine salvage pathway.

Carbohydrates are the primary source of energy in human diets. Essentially all carbohydrates are converted into glucose before they reach the cell. Once glucose enters the cell, enzymes in the cytoplasm or the nucleoplasm convert the glucose into pyruvic acid through a process called glycolysis. This process produces a small amount of ATP, while 90 percent of ATP is formed in the mitochondria. Pyruvic acid and acetoacetic acid (from fatty and amino acids) are converted into acetyl coenzyme-A in the cytoplasm and transported into the mitochondrion. Here a series of enzymes act upon acetyl coenzyme-A, which undergoes dissolution through a sequence of chemical reactions known as the tricarboxylic acid cycle or Krebs cycle. As a result of these processes, one molecule of glucose forms a total of 38 molecules of ATP.

ATP is vital to cellular function. Energy from ATP is required for membrane transport of glucose and other essential substances, such as sodium ions, potassium ions, calcium ions, phosphate ions, chloride ions, urate ions, hydrogen ions, and many other substances. Membrane transport is so important to cellular function that some cells utilize nearly half the ATP formed in the cells for this purpose alone.

ATP also supplies the energy to promote synthesis of a great number of substances, including proteins, phospholipids, cholesterol, purines, and pyrimidines. Synthesis of almost any chemical compound requires energy. For example, in the formation of one molecule of protein, many thousands of ATP molecules are broken down to release energy. Cells utilize up to 75 percent of all the ATP formed in the cell to synthesize new chemical compounds, particularly during the growth phase of a cell.

ATP is also essential for muscle contraction. In skeletal muscle, calcium ions bind to the troponin complex, causing the tropomyosin to shift and thereby expose the myosin binding sites of the actin to the myosin heads. The myosin heads move the thin filament contracting the muscle, also called a power stroke. ATP provides the energy required for the myosin heads to release the actin and move back into place for another power stroke. The amount of ATP that is present in the muscle fiber is sufficient to maintain full contraction for less than one second. The ATP is broken down into adensosine diphosphate (ADP), which is rephosphorylated to form new ATP within a fraction of a second. The two main sources of energy to reconstitute ATP are foodstuffs, such as carbohydrates, fats and proteins, and creatine phosphate.

Creatine is an amino acid derivative synthesized in the kidneys, liver, and pancreas from arginine, glycine, and methionine. The synthesis rate is about 1-2 g/d. Creatine can also be obtained through the diet, mainly from meat and fish. The average person consumes about 1 g creatine per day from a regular diet. In the body, creatine is degraded into creatinine and excreted in the urine at a rate of about 2 g/day.

About 90-95% of the body's creatine is found in skeletal muscle. Of this, approximately one-third is free creatine, and the remaining two-thirds exists as phosphocreatine. Creatine is transported to muscle tissue by the blood stream. Studies have shown an increase in creatine retention in the muscle tissue when taken with large amounts of carbohydrates, protein and carbohydrates, and with insulin mimickers like pinitol. Pinitol, a form of Vitamin B inositol, is a plant extract that has insulin-like properties and stimulates glucose uptake and glycogen synthesis.

Phosphocreatine serves a major role in energy metabolism. When energy demands in the body increase, phosphocreatine donates its phosphate to ADP to produce ATP. As ATP is depleted within the first second of exercise, phosphocreatine regenerates additional ATP at high rates for a few (10-15) seconds before the phosphocreatine store is emptied. Because phosphocreatine is a limiting factor in maintaining ATP resynthesis during maximal short-term exercise, an increased phosphocreatine concentration should theoretically increase the energy reserve for such exercise.

Physical activity, specifically high-intensity or prolonged exercise, requires a high rate of ATP utilization as well as a rapid rate of regeneration. The regeneration rate exceeds the maximum capacity of the muscle, resulting in the accumulation of ADP and adenosine monophosphate (AMP) in the muscle. With further adenine nucleotide degradation, inosine monophosphate (IMP) forms and accumulates in the muscle. A fraction of IMP is further degraded to nucleotide bases that are released into the bloodstream, resulting in a decrease in total adenine nucleotides (TAN, ATP+ADP+AMP) contributing to an overall decrease in ATP.

A single period of exhaustive exercise of short duration can cause ATP levels in human skeletal muscle to drop temporarily to 60-70% of resting values, but ATP levels are restored to pre-exercise levels shortly after the exercise is ended. However, the loss of nucleotides from frequently-repeated exercise exceeds the rate of regeneration, causing ATP levels to remain below baseline levels. Studies have shown that intense exercise performed regularly over one to several weeks decreases concentrations of ATP resting levels by 15-20%.

Each molecule of ATP consists of three phosphate groups and one adenosine molecule, which itself is composed of an adenine ring and a ribose molecule. Ribose is a pentose sugar found in many essential biological molecules, such as all nucleotides, nucleotide coenzymes, all forms of RNA, and ATP. Ribose is a key component and a limiting factor in the creation and regeneration of ATP. Ribose supplementation in rats has been shown to increase nucleotide salvage three- to six-fold and hypoxanthine salvage six- to eight-fold, depending on muscle fiber type. Ribose supplementation in humans has also been shown to attenuate loss of TAN during chronic high-intensity exercise, and return TAN and ATP levels to baseline within 65 to 72 hours. In contrast, subjects without ribose supplementation remained at under 80% of resting TAN and ATP levels. When consumed orally, 88-100% of ribose is absorbed in the intestines within two hours.

Coenzyme Q10 (CoQ10), like ribose, exists in all cells and is integral to many vital biological activities. Such activities include a role as an essential antioxidant, supporting the regeneration of other antioxidants, influencing the stability, fluidity and permeability of membranes, stimulating cell growth, and inhibiting cell death. Additionally, CoQ10 has a fundamental role in cellular bioenergetics as a cofactor in the mitochondrial electron transport chain (respiratory chain), and is therefore essential for the production of ATP. The human body can synthesize CoQ10 as well as derive it from several food products, including meat, fish, peanuts and broccoli. The dietary intake of CoQ10 is about 2-5 mg per day, while the total amount of CoQ10 in the body of a normal adult is estimated to be approximately 0.5-1.5 g. Studies have shown that the uptake of CoQ10 into the blood is approximately 5 to 10% of the dose administered. Dosages of 90 to 150 mg/day have shown to increase plasma concentrations by 180%. Under certain conditions including oxidative stress, production of CoQ10 may not meet the body's demand. In several medical studies and studies of trained athletes, CoQ10 supplementation has been shown to provide enhanced cellular energy levels in cardiac performance by increasing respiratory chain activity, improving oxygen utilization during exercise, accelerating post-exercise recovery, decreasing heart rate during exercise, improving performance, and increasing mean power (the average rate at which work is performed or energy is converted). CoQ10 has also been used as a supplementary treatment for diseases such as Chronic Heart Failure (CHF), muscular dystrophies, Parkinson's disease, cancer, and diabetes.

Low blood glucose or muscle glycogen levels during exercise contribute to fatigue. Maintaining or elevating body carbohydrate reserves may optimize exercise performance. Pre-exercise carbohydrate consumption has the potential to increase liver and muscle glycogen concentrations during the hours before exercise. Further, carbohydrates consumed prior to exercise may be absorbed via the small intestine during exercise and help maintain adequate blood glucose concentrations. Studies have shown a 15% increase in performance and a 13% improved endurance time to exhaustion with pre-exercise carbohydrate consumption. In some studies using carbohydrate solutions containing 200 g glucose per liter, performance was improved. Carbohydrate availability during exercise was greater and the pre-exercise carbohydrate consumption increased carbohydrate oxidation above normal amounts, thereby allowing a higher work rate during the later stages of exercise.

Electrolytes and minerals are crucial to increasing endurance and maintaining the body's physical capabilities during prolonged or highly-intense physical activity. Potassium and magnesium are known to play a major role in overcoming the effects of muscle fatigue. Substantial amounts of potassium and magnesium are lost from the contracting muscles during exercise, and there is a rapid decrease in plasma potassium after the cessation of exercise. A low extracellular potassium concentration can cause muscular weakness, changes in cardiac and kidney function, lethargy and even coma in severe cases. There are no reserves of potassium or sodium in the animal body, and any loss beyond the amount of intake comes from the body's own cells and tissues. The kidney is the key regulator of potassium and sodium. While the kidney can, with a low intake of sodium, reduce excretion thereof to a very low level to conserve the supply in the body, potassium is not so efficiently conserved.

Electrolytes are lost during physical activity through the process of hypotonic dehydration and isotonic dehydration, for example, through sweating or due to high ambient temperatures. The sodium concentration in sweat averages 35 mmol/L, while potassium, calcium and magnesium concentrations in sweat are 5, 1, and 0.8 mmol/L, respectively. Pre-exercise hydration with sodium and other electrolytes has been shown to decrease cardiovascular and thermal strain and enhance exercise capacity in trained and untrained men and women.

There are particular “energy drinks” on the market which purport to increase stamina and physical performance. These beverages generally contain various combinations of caffeine, electrolytes, sugars, juices, herbal extracts, and/or other components which act mainly as stimulants. However, none of these products are specifically designed for enhancing the biogeneration of ATP, nor do they include all the essential components parts of ATP generation or regeneration. Accordingly, there remains a need for a nutraceutical supplement composition which supports a biochemical ready source of cellular energy by promoting the biogeneration of ATP.

### II. SUMMARY OF THE INVENTION

The present invention is directed to a nutraceutical supplement composition for enhancing physical performance by enhancing the bio-availability of ATP energy reserves and the resynthesis of ATP in human skeletal muscle. Advantageously, the inventive composition increases the uptake and retention of creatine and stimulates the increase of ATP in skeletal muscle. The invention may also provide essential electrolytes and other ingredients to the consumer in order to support physical performance, attenuate muscle fatigue, and enhance aerobic respiration utilization capacity. The present invention can also be used as a nutritional supplement for human beings prior to physical activity. The present invention also provides a method for facilitating generation and regeneration of ATP lost by chronic, high-intensity or prolonged physical activity. The invention also provides a process for preparing the composition for oral consumption.

The nutraceutical supplement composition comprises ribose, coenzyme Q10, a saccharide, creatine, and D-pinitol. The strategic biochemical effect of the present invention works to increase the generation and regeneration of ATP to support the body's ability to perform greater work. Specifically, the combination of the individual components provides a synergistically enhanced effect on ATP generation and regeneration. Preparation of the consumable formulation immediately prior to ingestion (as discussed further below) provides for maximum potency, which supports (via research) the invention's enhanced effect on ATP generation and regeneration. Until recently, it was not possible to combine the components of this invention in a single nutraceutical composition due to the loss of potency of particular components when dissolved in water. This limitation has been overcome by the present invention. One aspect of the present invention is directed to an aqueous composition comprising the nutraceutical supplement composition for enhancing physical performance.

For ease of discussion, the inventive formulation will be termed a composition. It will be apparent from the surrounding text as to whether the composition is in the form of a ready-to-consume liquid composition, or in a solid form (such as, but not limited to, tablets, a powder, granulate, or concentrate), in which case the composition will be mixed with water, juice, or other fluid to form an aqueous solution at the time of ingestion.

The concentrations of the various components will generally vary within predetermined ranges to provide the desired degree of supplementation to the body. For example, in certain embodiments of the invention, the concentrations of the various components in liquid form can vary within the following ranges:
ribose: 25 to 83.3 grams per liter;
coenzyme Q10: 16.6 milligrams to 5 grams per liter;
saccharide: 16.6 to 333.3 grams per liter;
creatine (in the form of creatine monohydrate): 50 to 100 grams per liter; and
D-pinitol: 1 to 1,000 milligrams per gram of creatine.
All the indicated concentrations refer to concentrations in the prepared ready-to-consume composition.

The saccharide can conveniently be glucose or dextrose, although other easily-absorbable saccharides are within the scope of the present invention.

In aqueous solution, creatine begins to degrade into creatinine, a metabolic waste product, within days and weeks. Accordingly, creatine generally should not be added to a liquid solution at the time of manufacture, and should be kept physically separated from the remaining ingredients of the solution until shortly prior to ingestion to assure maximum potency. In liquid formulations of the present invention, the creatine can be stored in a specially designed compartment of the container or closure. Just before ingestion, the user will cause the creatine to be dispensed into the liquid solution. Advantageously, by activating the complete nutraceutical composition at the time of ingestion, maximum bio-availability of ATP energy reserves are provided without the use of steroidal-type compounds. The composition provides cellular-enhanced energy to perform physical activity or work. Other competitive compositions do not provide these components in a liquid form to increase ATP generation and regeneration.

For ease of discussion, all such liquid formulations of the inventive composition will be considered as “ready-to-consume” or “ready-to-use” and shelf-ready units even though they may have a final activation step to dispense the creatine into the liquid composition. Alternatively, the components can be maintained in dry form as a concentrate or powder, and added to water shortly prior to ingestion.

The nutraceutical composition may further comprise one or more minerals or electrolytes. These minerals or electrolytes may be selected from the group consisting of sodium, potassium, calcium, and magnesium. In further embodiments, additional minerals or vitamins can be added for further supplementation. The minerals may be in the form of conventional biologically-acceptable salts, such as chlorides, carbonates, and citrates. For ease of discussion, the minerals or electrolytes will be referred to without counterion, although it will be understood the minerals will be in the form of a biologically acceptable salt or other compound.

For example, if the nutraceutical composition contains sodium, potassium, calcium, and/or magnesium as minerals or electrolytes, the concentrations of these components in the final liquid form can vary within the following ranges:
sodium: 16.6 milligrams to 5 grams per liter;
potassium: 16.6 milligrams to 3.3 grams per liter;
calcium: 16.6 milligrams to 1.6 grams per liter; and
magnesium: 16.6 milligrams to 1.6 grams per liter.

The nutraceutical composition may further comprise a preservative to maintain the quality of the product. The preservative can be a commercially-available substance with known preservation properties, such as sodium chloride, sodium citrate, sodium benzoate, or a mixture of these or other preservatives.

The water content of the nutraceutical composition will be sufficient to give the desired effective concentration ranges for the various components. In one embodiment, the water content may be in the range of from 800-900 grams per liter of prepared beverage. When the composition is sold in solid form, the packaging will provide specific instructions as to the amount of water (or other liquid) to be added.

The composition may also contain an acidulant to adjust the pH to a desired pH level, for example, to provide acidity for stability of the components, or tartness for a satisfying taste sensation. The acidulant can be any known or commercially-available biologically-acceptable acidifying substance. For example, the acidulant can be selected from the group consisting of citric acid, lactic acid, maleic acid, tartaric acid, and combinations thereof, and the pH can be adjusted to 3-6.5, or any other, particular biologically-acceptable value.

The composition may also contain common flavoring and/or coloring ingredients to provide a particular taste or appearance. These flavors or colors can be natural or synthetic, and may be added in accordance with techniques known in the art. For example, the resultant composition may contain flavorings such as kiwi, pomegranate, green tea lemonade, mixed berry, tropical citrus, or blueberry. The various components of the liquid composition do not need to be completely dissolved, and the composition may be consumed in the form of a suspension, emulsion or other non-homogeneous mixture. Any undissolved solid material will generally be minimal. Certain components of the composition may have multiple functions, such as but not limited to preservatives, sources of electrolytes, and/or acidulants.

Another embodiment of the invention is directed to a nutraceutical composition for enhancing physical performance. The composition comprises the following components per liter in liquid form:
ribose: 25 to 83.3 grams;
coenzyme Q10: 16.6 milligrams to 5 grams
saccharide: 16.6 to 333.3 grams
creatine (as creatine monohydrate): 50 to 100 grams
D-pinitol: 1 to 1,000 milligrams per gram of creatine;
sodium: 16.6 milligrams to 5 grams
potassium: 16.6 milligrams to 3.3 grams
calcium: 16.6 milligrams to 1.6 grams
magnesium: 16.6 milligrams to 1.6 grams
preservative; and
an acidulant.

In a preferred embodiment of the invention, the nutraceutical composition may contain the following components per liter in liquid form:
ribose: 25-83.3 grams
coenzyme Q10: 1.5-5 grams
creatine monohydrate: 50-100 grams
D-pinitol: 1-1000 mg per gram of creatine
saccharide: 167-300 grams
sodium: 1-3.5 grams
potassium: 420 milligrams-2.5 grams
calcium: 170 milligrams-1 gram;
magnesium: 80 milligrams-1 gram;
preservative; and
an acidulant

The composition may be sold as a shelf-stable ready-to-drink bottled liquid, in which all of the components except for the creatine are mixed within the water solution. The creatine can be placed in a specially-prepared compartment of the container, such as in the cap, to keep the creatine sealed from the liquid. Just prior to consumption, a dispensing mechanism can be activated to dispense the creatine into the liquid, for example, using a closure-activated mechanism shortly before consumption. The container can be a bottle, can, or other commercially-available container which can be used to contain the liquid for shelf storage. Examples of such dispensing mechanisms include: VIZcap dosing and dispensing bottle caps, from VIZ Enterprises LLC (Atlanta, Ga.); Teamplast dispensing bottle caps from Teamplast (Heteren, the Netherlands); dispensing closures, manufactured by MPI Packaging; and Delo cap-capsule, DELO (France).

The novel composition may also be sold in the form of a tablet, powder, granulate, ready-to-dissolve dry concentrate, or similar dry formulation for reconstitution by the consumer.

Methods for making such tablet, powder, granulate, or other solid formulations are readily known to the person of ordinary skill in the art. The dry composition can be sold in individual units such as sachets or stick-packs, or in bulk multi-dose packages. The liquid formulation may be readily prepared by the consumer by adding the dry composition to a predetermined quantity of water (or other fluid) shortly before consumption. After mixing, the liquid is ready for consumption.

In tabletted embodiments, the composition may comprise binders, lubricants, disintegrants, and/or other known tablet excipients. These tabletting excipients can be added to the other components of the composition during blending. Other solid formulations may also contain known excipients to improve flow, absorb moisture, or reduce degradation to provide for a satisfactory customer experience. Proportions of ingredients for the solid formulations are generally the same as for the ready-to-drink formulations.

The concentrate can also be sold in “shot” packs, bottles, or other containers. For example, the manufacture can sell a 60 ml, 100 ml, or other-sized bottle containing the dry powder composition, and the consumer would simply add a pre-determined amount of water or other fluid to the bottle and shake the contents. The bottles can be single-use or reusable, depending on the manufacturer's preference and marketing plans.

Another aspect of the invention is directed to a method of enhancing physiologically essential energy stores in human skeletal muscle. The method comprises administering an effective amount of the novel composition to a subject in need thereof.

The liquid composition can be consumed at any time to enhance the consumer's ability to generate and regenerate ATP levels. For example, the composition can be consumed 1-2 hours prior to physical activity to build up the stores of the ATP components.

The components of the liquid composition do not need to be completely dissolved prior to consumption. That is, a minor portion of components may remain undissolved, and the liquid composition may be consumed in the form of a suspension, emulsion, or other non-homogeneous formulation. The amount of any such undissolved solids in the liquid composition will generally be minimal and will not affect the efficacy of the liquid composition. Commercial packages of the composition will generally have a label with directions regarding recommended and maximum daily consumption guidelines.

### III. DETAILED DESCRIPTION OF THE INVENTION

The composition and methods of the present invention are particularly suitable to anyone who engages in chronic physical activity, such as high-intensity and/or prolonged physical exercise.

Advantageously, the use of ribose in the novel composition facilitates generation of ATP, and enhances aerobic respiration utilization capacity. The ribose also attenuates muscle fatigue and decreases free radical formation during exercise. A preferred range of ribose in the inventive composition is 25 to 83.3 grams per liter. Ribose levels as high as 15 g per day can be safely ingested. Ribose has not been shown to have any lasting or damaging side effects during extended dosing regimens, though there are two known side effects of taking ribose in doses of 10 grams or more on an empty stomach. The first is transient hypoglycemia (low blood sugar) that can be eliminated by taking larger doses of ribose with other carbohydrates, as provided in the present invention. The second side effect that may occur in some individuals is gastro-intestinal discomfort, including loose stools and diarrhea. Suitable forms of ribose include, but are not limited to, synthetically-made ribose extract from fermented yeast.

The carbohydrates in the inventive composition, specifically dextrose/glucose and ribose, provide a source of energy to extend exercise and improve performance of highly-intensive and/or prolonged physical activity. During exercise, glucose is needed to replace and increase muscle glycogen to prevent adverse effects of exercise on the body. A preferred range of dextrose or glucose in the composition is 16.6 to 333.3 grams per liter of prepared composition.

Creatine in the inventive composition increases ATP activity through increasing phosphocreatine stores. Normal concentration of total creatine in skeletal muscle is about 120 mmol/kg, and the upper limit appears to be about 150-160 mmol/kg. Studies have reported that supplementation with 3-6 g/d of creatine was sufficient to increase muscle creatine stores without a loading period (e.g., 20-30 g/d for 3-7 days). The International Society of Sports Nutrition states, “[m]any anecdotal claims of side effects including dehydration, cramping, kidney and liver damage, musculoskeletal injury, gastrointestinal distress, and anterior (leg) compartment syndrome still exist in the media and popular literature. While athletes who are taking creatine monohydrate may experience these symptoms, the scientific literature suggests that these athletes have no greater, and a possibly lower, risk of these symptoms than those not supplementing with creatine monohydrate.” (Buford et al., “International Society of Sports Nutrition Position Stand: Creatine Supplementation and Exercise”, J. Intl. Soc. Sports Nutr., 2007, 4:6) Normal creatine intakes, e.g., less than 25 g/d for 5 days (loading period) and 5 g/d over 14 days or 10 months to 5 years, do not cause renal dysfunction.

Creatine is commercially isolated from meat extracts, and creatine and its derivatives are available from a number of commercial sources. Creatine in the form of a monohydrate is suitable for use in the present invention. Other suitable derivatives of creatine include creatine monohydrates, creatine phosphates, creatine esters such as creatine ethyl ester, creatine citrate, creatine ascorbate, creatine pyruvate, cyclo-creatine and other salts thereof. A preferred range of creatine monohydrate in the current composition is 50 to 100 grams per liter of prepared composition. As previously discussed, creatine generally will not be added to the liquid composition at the time of manufacture because creatine begins to degrade in water into creatinine within days or weeks. Therefore, the creatine will be kept dry to prevent, or at least minimize, conversion to creatinine. The creatine can be kept dry by storing the creatine in a special compartment of the beverage container, such as in the cap, or by packaging the solid composition in a sealed sachet, stick-pack, or other suitable package which is sealed from the air. The dry container will keep the granulate, tablet, or other beverage concentrate form from deterioration.

D-Pinitol can facilitate the uptake of creatine into the skeletal muscle. D-pinitol is available commercially, and can be extracted from a number of plant sources, including alfalfa, Bougainvillea leaves, chickpeas, pine trees and soybeans. A preferred range of D-pinitol is 1 to 1,000 milligrams per gram of creatine.

Coenzyme Q10 (CoQ10) enhances ATP production and aerobic respiration utililation capacity, and attenuates muscle fatigue and decreases free radical formation during exercise. A preferred range of CoQ10 in the current composition is 16.6 mg to 5 grams per liter of prepared composition. CoQ10 has been shown to be safe and well tolerated at dosing levels as high as 3,000 mg per day over 8 months. In cardiovascular-related clinical trials encompassing 2,152 patients using 100 to 200 mg per day, CoQ10 has been shown to be safe, without any reports of toxicity or drug interactions. Less than one percent of CoQ10 users may experience gastrointestinal side effects such as nausea, vomiting, diarrhea, appetite suppression, heartburn, and epigastric discomfort. Suitable forms of Coenzyme Q10 include, but are not limited to, synthetically-made coenzyme Q10 extract including 10% CoQ10 Liposomes.

In addition to the components discussed above, the composition may further comprise electrolytes, minerals, and essential nutrients, such as sodium, potassium, calcium and magnesium. The minerals and electrolytes provide essential nutrients for cellular and organ functions. They also attenuate muscle fatigue and delay the onset of exercise-associated muscle cramps during physical activity. Additionally, these electrolytes and minerals decrease cardiovascular and thermal strain and enhance exercise capacity in trained and untrained men and women. A preferred ranges of electrolytes or minerals in the composition are as follows:
sodium: 16.6 mg to 5 grams per liter;
potassium: 16.6 milligrams to 3.3 grams per liter;
calcium: 16.6 milligrams to 1.6 grams per liter; and
magnesium: 16.6 milligrams to 1.6 grams per liter.
   Examples of suitable electrolytes include, but are not limited to, sodium chloride, sodium citrate, sodium benzoate, other sodium salts and mixtures thereof. Suitable sources of the minerals and electrolytes include, but are not limited to, biologically acceptable salts such as chlorides, sorbates, citrates, and the like, as well as mixtures thereof.

When the composition is sold in a ready-to-drink form, the liquid composition will be formulated to provide the components at a particular concentration. When the composition is sold as a powder, granulate or other solid, the package will contain instructions on how to reconstitute the beverage. For example, the package may state “Add to 12 oz. of water and shake well”. The package may also contain additional information such as recommended or maximum daily consumption guidelines, nutritional information, and the like. In one embodiment, the ready-to-drink liquid composition will be packaged in a container of approximately 60 ml. The containers may be disposable, although they are preferably recyclable or reusuable. Unconsumed portions of the beverage may be discarded, or refrigerated for up to 3 days to maintain product quality.

Although the solid composition is developed for admixture with water, certain persons may wish to dissolve the composition in another liquid, such as juice or carbonated water.

As previously discussed, the composition within the scope of this invention may take a variety of forms. For instance, the composition may be manufactured and sold as a ready-to-drink liquid composition. The present invention may also be prepared in concentrate or powder form to be reconstituted for use by the consumer by the addition of water or another liquid. Such reconstitution is to be made with the requisite amounts of water to ensure that the beverage contains the active components in the recommended proportions. In another embodiment, the freshly-prepared liquid may be prepared and then frozen. The frozen liquid can be defrosted and ingested by the consumer, or it may be eaten as a frozen ice or similar novelty. In the frozen state, creatine has a significantly longer stability, and degradation to creatinine is minimized by the cold temperature.

In order to prevent or at least significantly minimize the conversion of creatine to creatinine in the liquid composition, the bottle, can, brick-pack, or other container may have a specific compartment for the creatine. These containers will keep the creatine dry and sealed away from the liquid. A tamper-resistant wrapping can be provided on the package to further ensure product quality.

Preparation of the ready-to-drink liquid composition comprising the inventive nutraceutical supplement composition is generally straightforward. In one embodiment, the liquid composition can be prepared by mixing the ingredients using the following procedure.
(1) Preservatives are mixed with d-ribose and the saccharide.
(2) CoQ10 is mixed with D-pinitol.
(3) If used, any electrolytes such as calcium, magnesium, potassium and sodium are mixed together.
(4) Items 1-3, are mixed and brought to solution in distilled water.
(5) An acidulant, such as citric acid, is added to the solution to adjust the pH to the desired level.
(6) The solution is packaged in a conventional aseptic bottle, can, brick-pack or other beverage container.
(7) The creatine monohydrate is measured and form-filled, and encased within a specific dispensing mechanism to keep the creatine separate from the liquid solution. To consume the beverage, the user would activate the creatine-dispensing mechanism to dispense the creatine monohydrate into the liquid solution immediately prior to consumption.
   The liquid composition is made up using distilled or purified water, with a maximum calorie load of 1,675 kcal/liter, optionally flavored with any choice of natural or synthetic fruit extract and/or aroma, such as pomegranate, gojiberry, blueberry, carrot, beet or others. The intended intake will normally be one 60 ml bottle per day, although dosing will depend on the concentration of the components.

As discussed, the composition described may be prepared and sold as a dry powder mixture for reconstitution by the consumer. The dry powder mixture can be prepared to provide a similar calorie load, flavoring, and coloring as the liquid ready-to-drink liquid. In this embodiment, the components of the nutraceutical composition are mixed in a conventional solids blending or mixing apparatus, and packaged into single-use portions, tablets, or other packages, or in bulk-sized multiple-portioned containers. A single unit package can be intended for dissolution in 50 or 100 ml of water or other liquid.

For improving physical and athletic performance, an average human need only ingest one serving per day of the liquid as described. Depending on the concentration of the liquid, in certain embodiments, more than one serving can be consumed. For optimal effects, the beverage can be consumed 1-2 hours prior to physical activity, such as an athletic event or athletic training. Consumption of the liquid composition prior to athletic competition or other periods of strenuous activity will supply the body with electrolytes to buffer against negative effects of electrolyte loss lost during profuse sweating. The concentrations are merely indicative, and more concentrated or diluted drinks may be prepared using the same general formulation.

While the composition is not intended to be a pharmaceutical composition to treat medical conditions or diseases, the intake of the composition will help prevent negative effects of strenuous physical activity, such as fatigue, exhaustion, muscle cramps, etc. The present invention can also be beneficial for individuals who exhibit symptoms of fatigue including, but not limited to, those patients suffering from ischaemia, myoadenylate deaminase deficiency, AMP deaminase deficiency, congestive heart failure, chronic fatigue syndrome, fibromyalgia, and McArdle's disease.

The following examples further illustrate the nature of the present invention. The examples are by no means considered as restrictions or limitations of the present invention.

### EXAMPLE 1

### Ready-to-Drink Formulations

A liquid composition was prepared containing the following components for each 2 fluid ounces (60 ml) of liquid:

TABLE 1

| | |
|---|---|
| Ribose | 3 gm |
| Coenzyme Q10 | 100 mg |
| Creatine monohydrate | 3 gm |
| D-Pinitol | 5 mg |
| Dextrose/glucose | 12.5 gm |
| Trisodium citrate | 220 mg |
| Sodium benzoate | 25 mg |
| Monopotassium phosphate | 164 mg |
| Potassium sorbate | 33 mg |
| Citric acid | 450 mg |
| Calcium lactate | 215 mg |
| Magnesium lactate | 210 mg |
| Deionized water | 48.14 gm |
| pH | 3.2-4.5 |
| Citrus punch flavoring | 22 mg |
| Food-grade colorant | 15 mg |

The liquid composition was prepared by mixing the ingredients in a specified order. (1) The preservatives (sodium benzoate and potassium sorbate) are mixed with d-ribose and glucose. (2) CoenzymeQ10 is mixed with d-pinitol. (3) The calcium, magnesium, potassium and sodium salts, and the remaining components (except citric acid and creatine monohydrate), are mixed together. (4) Ingredients 1-3, are mixed and brought to solution in distilled water. (5) Citric acid is added to the solution to achieve pH=3.2-4.5. (6) The prepared solution is packaged in a conventional aseptic 2 fl. oz. bottle. (7) The creatine monohydrate is measured into a special closure mechanism to keep this ingredient separate from the liquid solution.

To consume the liquid composition, the user would remove a tamper evident wrap, then twist or push down on the button portion of the closure and then shake the bottle. This action of pushing down on the exposed button section of the closure causes the creatine compartment in the closure to be punctured and the creatine to be dispensed into the liquid composition. After shaking to dissolve or disperse the creatine, the composition is ready for consumption.

### EXAMPLE 2

### Stick-Pack Units

Stick-packs containing the powdered nutraceutical composition were prepared by blending the following ingredients in a solids mixing apparatus using a wet-granulation or solid-granulation technique:

TABLE 2

| | |
|---|---|
| Ribose | 3 gm |
| Coenzyme Q10 | 100 mg |
| Creatine monohydrate | 3 gm |
| D-Pinitol | 5 mg |
| Dextrose/glucose | 12.5 gm |
| Trisodium citrate | 220 mg |
| Sodium benzoate | 25 mg |
| Monopotassium phosphate | 164 mg |
| Potassium sorbate | 33 mg |
| Citric acid | 450 mg |
| Calcium lactate | 215 mg |
| Magnesium lactate | 210 mg |
| pH | 3.2-4.5 |
| Citrus punch flavoring | 22 mg |
| Food-grade colorant | 15 mg |

The blended powder was packaged into 3 stick-packs. Sufficient citric acid was included in the blended powder so that the reconstituted liquid composition would have a pH of 3.2 to 4.5. To prepare the liquid composition, the contents of three single stick-packs are added to a 16.9 or 20 ounce-sized bottle of water. After shaking the bottle to dissolve or disperse the contents, the liquid composition is ready to consume. In an alternative embodiment, the formulation can be packaged into a single stick-pack, and the user would dissolve or dispense the contents of the stick-pack into 16.9 or 20 oz of water (or other fluid).

### EXAMPLE 3

### Tablets

Tablets containing the nutraceutical composition were prepared by blending the following ingredients in a solids mixing apparatus:

TABLE 3

| | |
|---|---|
| Ribose | 3 gm |
| Coenzyme Q10 | 100 mg |
| Creatine monohydrate | 3 gm |
| D-Pinitol | 5 mg |
| Dextrose/glucose | 12.5 gm |
| Tri sodium citrate | 220 mg |
| Sodium benzoate | 25 mg |
| Monopotassium phosphate | 164 mg |
| Potassium sorbate | 33 mg |
| Citric acid | 450 mg |
| Calcium lactate | 215 mg |
| Magnesium lactate | 210 mg |
| pH | 3.2-4.5 |
| Citrus punch flavoring | 22 mg |
| Food-grade colorant | 15 mg |

Sufficient citric acid was added to the ingredients so that the reconstituted liquid would have a pH of 3.2-4.5. The blended powder was compressed using a tablet press to form two tablets. To prepare the liquid composition, two tablets are added to an 8-oz sized glass or bottle of water. After mixing or shaking the glass or bottle to dissolve or disperse the tablets, the liquid is ready to consume. Dispersants, disintegrants, lubricants, or other typical tabletting excipients can be added to the tablet for facile tablet preparation or dissolution.

While the invention has been particularly shown and described with reference to particular embodiments, those skilled in the art will understand that various changes in form and details may be made without departing from the spirit and scope of the invention.

1. A nutraceutical supplement composition for enhancing physical performance, the nutraceutical composition comprising ribose, coenzyme Q10, a saccharide, creatine, and D-pinitol.

2. The nutraceutical supplement composition according to claim 1, further comprising one or more minerals.

3. The nutraceutical supplement composition according to claim 2, wherein the one or more minerals are selected from the group consisting of sodium, potassium, calcium, and magnesium.

4. The nutraceutical supplement composition of claim 1, further comprising a preservative selected from the group consisting of sodium chloride, sodium citrate, sodium benzoate, and mixtures thereof.

5. The nutraceutical supplement composition of claim 1, further comprising an acidulant selected from the group consisting of citric acid, lactic acid, maleic acid, tartaric acid, and combinations thereof.

6. The nutraceutical supplement composition according to claim 1, wherein the saccharide is glucose or dextrose.

7. The nutraceutical supplement composition according to claim 1, wherein the creatine is in the form of creatine monohydrate.

8. The nutraceutical supplement composition according to claim 1, wherein the nutraceutical supplement composition is in a form selected from the group consisting of a liquid, tablets, powder, granulate, stick-pack and ready-to-dissolve concentrate.

9. The nutraceutical supplement composition according to claim 8, wherein the liquid is pre-prepared and ready-to-consume.

10. The nutraceutical supplement composition according to claim 9, wherein the creatine is physically separated from the remaining ingredients of the nutraceutical supplement composition until at the time of ingestion when the creatine is added to the liquid.

11. The nutraceutical supplement composition according to claim 8, wherein the liquid is prepared by adding the tablets, powder, granulate, stick-pack or ready-to-dissolve concentrate to a pre-determined amount of water.

12. The nutraceutical supplement composition according to claim 8, wherein the concentration of ribose is in the range of from 25 to 83.3 grams per liter of the liquid.

13. The nutraceutical supplement composition according to claim 8, wherein the concentration of coenzyme Q10 is in the range of from 16.6 milligrams to 5 grams per liter of the liquid.

14. The nutraceutical supplement composition according to claim 8, wherein the concentration of the saccharide is in the range of from 16.6 to 333.3 grams per liter of the liquid.

15. The nutraceutical supplement composition according to claim 8, wherein the creatine is in the form of creatine monohydrate, and wherein the concentration of the creatine monohydrate is in the range of from 50 to 100 grams per liter of the liquid.

16. The nutraceutical supplement composition according to claim 1, wherein the concentration of D-pinitol is in the range of from 1 to 1,000 milligrams per gram of creatine.

17. The nutraceutical supplement composition according to claim 8, wherein the concentration of sodium is in the range of from 16.6 milligrams to 5 grams per liter of the liquid.

18. The nutraceutical supplement composition according to claim 8, wherein the concentration of potassium is in the range of from 16.6 milligrams to 3.3 grams per liter of the liquid.

19. The nutraceutical supplement composition according to claim 8, wherein the concentration of calcium is in the range of from 16.6 milligrams to 1.6 grams per liter of the liquid.

20. The nutraceutical supplement composition according to claim 8, wherein the concentration of magnesium is in the range of from 16.6 milligrams to 1.6 grams per liter of the liquid.

21. The nutraceutical supplement composition according to claim 8, wherein the water content of the liquid is in the range of from 800-900 grams per liter of the liquid.

22. A nutraceutical liquid composition for enhancing physical performance, the liquid comprising:
glucose in the range of from 15 to 340 grams per liter of the liquid;
ribose in the range of from 25 to 85 grams per liter of the liquid;
coenzyme Q10 in the range of from 15 milligrams to 5 grams per liter of the liquid;
creatine monohydrate in the range of from 50 to 100 grams per liter of the liquid;
D-pinitol in the range of from 1 to 1,000 milligrams per gram of creatine;
sodium in the range of from 15 milligrams to 5 grams per liter of the liquid;
potassium in the range of from 15 milligrams to 3.5 grams per liter of the liquid;
calcium in the range of from 15 milligrams to 2 grams per liter of the liquid;
magnesium in the range of from 15 milligrams to 2 grams per liter of the liquid;
a preservative; and
an acidulant.

23. A method of preparing the liquid according to claim 10, the method comprising adding the creatine to the liquid at the time of ingestion using a closure-activated mechanism.

24. A method of preparing the liquid according to claim 11, the method comprising adding the tablets, powder, granulate, or ready-to-dissolve dry concentrate to a predetermined quantity of water and mixing at the time of ingesting the liquid.

25. A method of enhancing physiologically essential energy stores in human skeletal muscle, the method comprising ingesting an effective amount of the nutraceutical supplement composition of claim 1 by a subject in need thereof.

26. A liquid composition comprising creatine and a fluid portion and packaged in a container having a closure, wherein during storage, the creatine is located in the closure of the container and is physically separated from the fluid portion in the container.

27. The liquid composition according to claim 26, wherein the composition is prepared at the time of ingestion by activating the closure to dispense the creatine into the fluid portion.

28. The liquid composition according to claim 26, wherein the fluid portion comprises water.

29. A method for preparing the nutraceutical supplement composition according to claim 10, the method comprising:
a. combining the ribose, saccharide, and optionally a preservative;
b. separately combining the coenzyme Q10 with the D-pinitol;
c. separately combining any optional minerals;
d. adding items (a), (b), and (c) to water and mixing to form a mixture;
e. optionally adding an acidulant to adjust the pH of the mixture;
f. packaging the mixture in a container; and
g. packaging the creatine in a separate portion of the container, wherein the creatine is physically separated from the mixture.
